(19) United States
(12) Patent Application Publication
(10) Pub. No.: US 2023/0166622 A1
(43) Pub. Date: Jun. 1, 2023

(54) MULTI-PURPOSE CHARGER

(71) Applicant: Molex, LLC, Lisle, IL (US)

(72) Inventors: Luis Ramses Rubio ROMERO, Troy, MI (US); Gregory L. BELLA, Naperville, IL (US); Jeffrey R. CIARLETTE, Lockport, IL (US)

(73) Assignee: Molex, LLC, Lisle, IL (US)

(21) Appl. No.: 17/989,809

(22) Filed: Nov. 18, 2022

Related U.S. Application Data
(60) Provisional application No. 63/283,534, filed on Nov. 29, 2021.

(51) Int. Cl. B60L 53/62; B60L 53/16

(52) U.S. Cl. CPC B60L 53/62; B60L 53/16

(57) ABSTRACT

A charging system includes first and second ports supported by a single power supply, which is configured to support Universal Serial Bus (USB) Power Delivery (PD) power levels. A controller is configured to provide a negotiated PD power level from the single power supply to the first port when, in operation, only a single first device is connected to the charging system via the first port. The controller is further configured to reduce the power available to the first and second ports to a preset level from the single power supply when, in operation, a second device is connected to the charging system via the second port such that the first and second devices are both connected to the charging system.

### RELATED APPLICATION

This application claims priority to U.S. Provisional Patent Application Ser. No. 63/283,534 filed Nov. 29, 2021, which is incorporated herein by reference in its entirety.

### TECHNICAL FIELD

This disclosure relates to the field of chargers, more specifically to chargers suitable for use in vehicle applications.

### DESCRIPTION OF RELATED ART

Chargers positioned in vehicles are known to provide multiple ports (e.g., two or more ports, c/c.) that support various charging capabilities. One such charging specification is known as Universal Serial Bus (USB) Power Delivery (PD). PD modes are available to support a range of different charging rates. And the charger can negotiate with the device seeking to be charged to determine the appropriate voltage and current that is compatible with the device and the charging system. One issue that exists, however, is that existing solutions are overly expensive because it is desirable for multiple ports to provide the desired PD mode, which necessitates the use of multiple power supplies, one for each port. in addition to the cost, the need to design the system so it can adequately support the total voltage and current levels delivered by both ports requires the use of larger diameter conductors, which increases weight and cost. Thus, certain individuals would appreciate further improvements to existing charger designs.

### SUMMARY

This section provides a general summary of the disclosure and is not a comprehensive disclosure of its full scope or all of its features.

A charging system includes first and second ports supported by a single power supply, which is configured to support Universal Serial Bus (USB) Power Delivery (PD) power levels. A controller is configured to provide a negotiated PD power level from the single power supply to the first port when, in operation, only a single first device is connected to the charging system via the first port. The controller is further configured to reduce the power available to the first and second ports to a preset level from the single power supply when, in operation, a second device is connected to the charging system via the second port such that the first and second devices are both connected to the charging system.

Further areas of applicability will become apparent from the description provided herein. The description and specific examples in this summary are intended for purposes of illustration only and are not intended to limit the scope of the present disclosure.

### DRAWINGS

The present application is illustrated by way of example and not limited in the accompanying figures in which like reference numerals indicate similar elements and in which:

FIG. 1 is a schematic representation of a circuit for a charging system, power delivery module, or charger configured to be operable for providing power to multiple ports (e.g., first and second USB Type-C ports, etc.) according to an exemplary embodiment of the present disclosure.

FIG. 2 is a schematic representation of a circuit for a charging system, power delivery module, or charger configured to be operable for providing power to multiple ports first and second USB Type-C ports, etc.) according to an exemplary embodiment of the present disclosure.

FIG. 3 illustrates a multiple port module connected to power and that may include the circuit shown in FIG. I and/or the circuit shown in FIG. 2 according to an exemplary embodiment of the present disclosure.

FIG. 4 is a back perspective view of the multiple port module shown in FIG. 3.

FIG. 5. is a right side view of the multiple port module shown in FIG. 3.

FIG. 6 is a front view of the multiple port module shown in FIG. 3.

FIG. 7 is an exploded perspective view of the of the multiple port module shown in FIG. 3 in which first and second portions of the housing or mechanical enclosure have been removably detached and separated from each other to thereby reveal internal components of the multiple port module.

FIG. 8 illustrates a multiple port module connected to power and that may include the circuit shown in FIG. 1 and/or the circuit shown in FIG. 2 according to an exemplary embodiment of the present disclosure.

FIG. 9 is an exploded perspective view of the multiple port module shown in FIG. 8 in which upper and lower portions of a housing or mechanical enclosure have been removably detached and separated from each other to thereby reveal internal components of the multiple port module.

FIG. 10 is a flow chart of an example method for providing power to a plurality of ports that includes a first, port and a second port from a single power supply configured to support Universal Serial Bus (USB) Power Delivery (PD) power levels according to an exemplary embodiment of the present disclosure.

### DETAILED DESCRIPTION OF THE PREFERRED EMBODLMENTS

The detailed description that follows describes exemplary embodiments and the features disclosed are not intended to be limited to the expressly disclosed combination(s). Therefore, unless otherwise noted, features disclosed herein may be combined together to form additional combinations that were not otherwise shown for purposes of brevity.

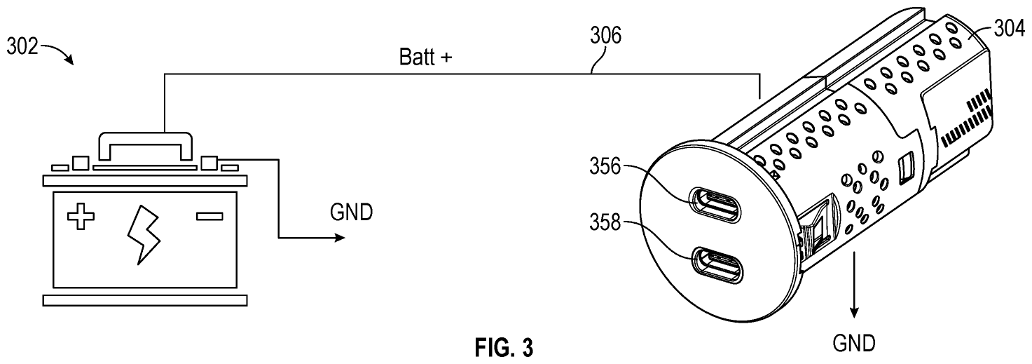

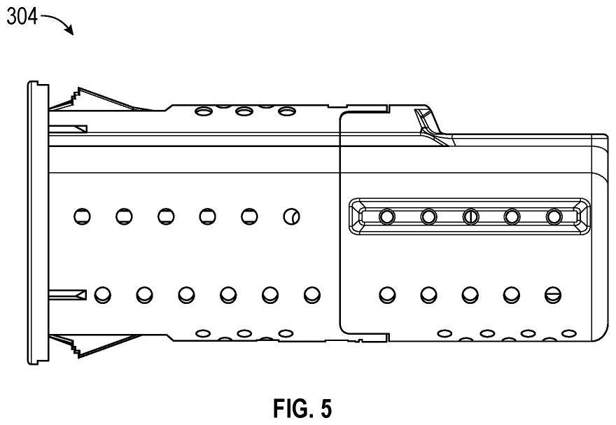

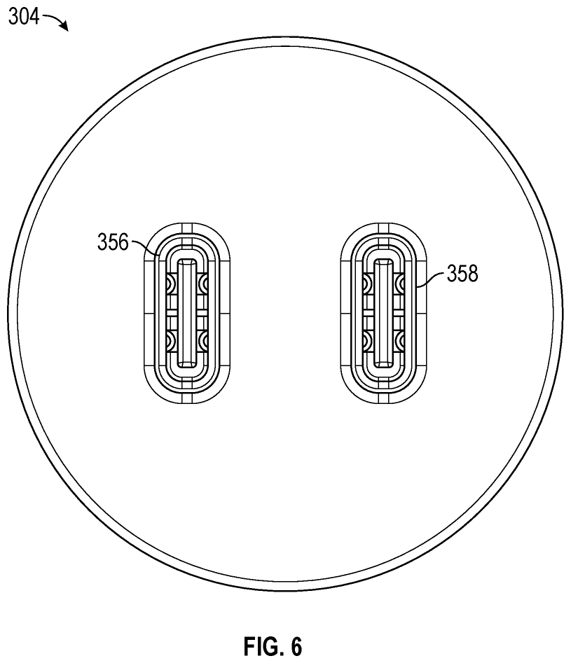

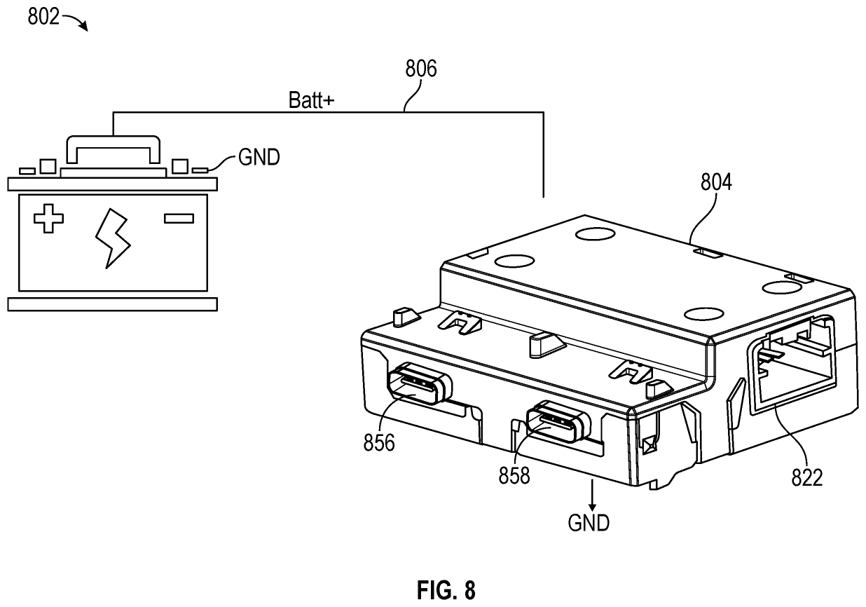

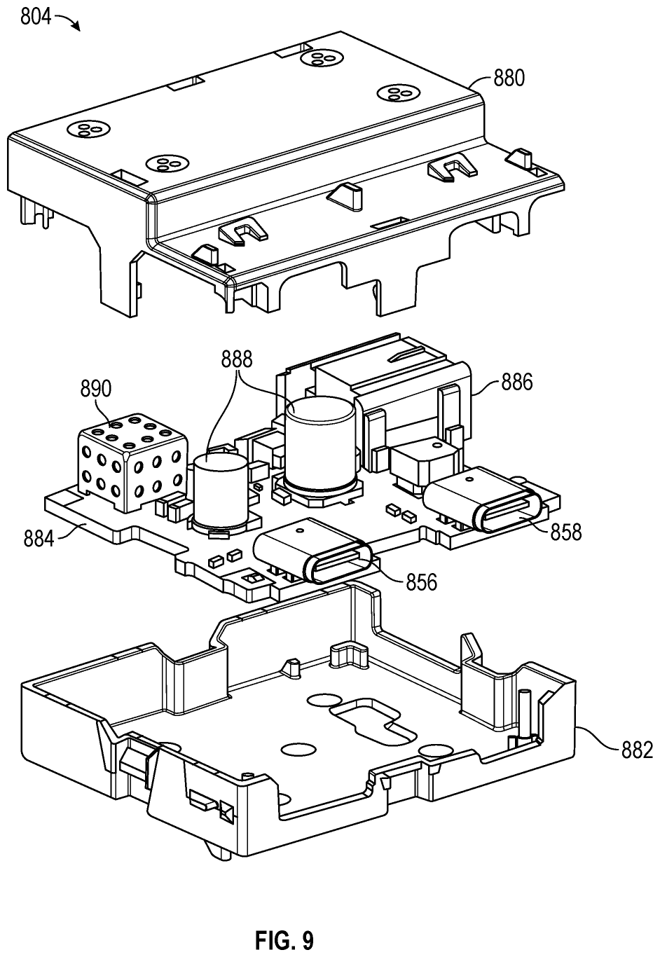

Disclosed herein are exemplary embodiments of charging systems, power delivery modules, and chargers configured to be operable for providing power from a single power supply to multiple ports. In exemplary embodiments, the charging system, power delivery module, or charger is configured to be operable for providing power from a single power supply to at least a first port and a second port of a rnultiport module, such as a multiple port module 304 (FIGS. 3-7) for a vehicular panel mount charging system or a multiple port module 804 (FIGS. 8 and 9) for a vehicular embedded charging system, etc. While two ports are shown, additional ports may be provided as desired (for example, three ports or four ports could be provided in a module). Each of the ports can have their own desired configuration, for example, without limitation, each port could be a USB Type-A configuration, a USB Type-C configuration, or some other desirable configuration. By way of background, a USB Type-C port is a 24-pin USB connector system with a rotationally symmetrical connector. In contrast, a USB Type-A port provides either 4 or 9 pins (depending on the version) and mates with rectangular connector in a single orientation.

In exemplary embodiments, the charger is configured to be operable with a single power supply to provide USB power delivery (PD) power at approximately the rated maximum power delivery capability of the power supply to a single first device that is connected to one of the ports when only the first device is connected to the charger. When an additional device is also connected to charger via another port such that there are two devices connected to the charger via the corresponding ports, the charger can be configured to controllably switch the power supply to a reduced shared voltage to the first and second ports for the respective two connected devices. For example, the charger can supply the same voltage to both the first and second ports while limiting the current to a predetermined or preset level.

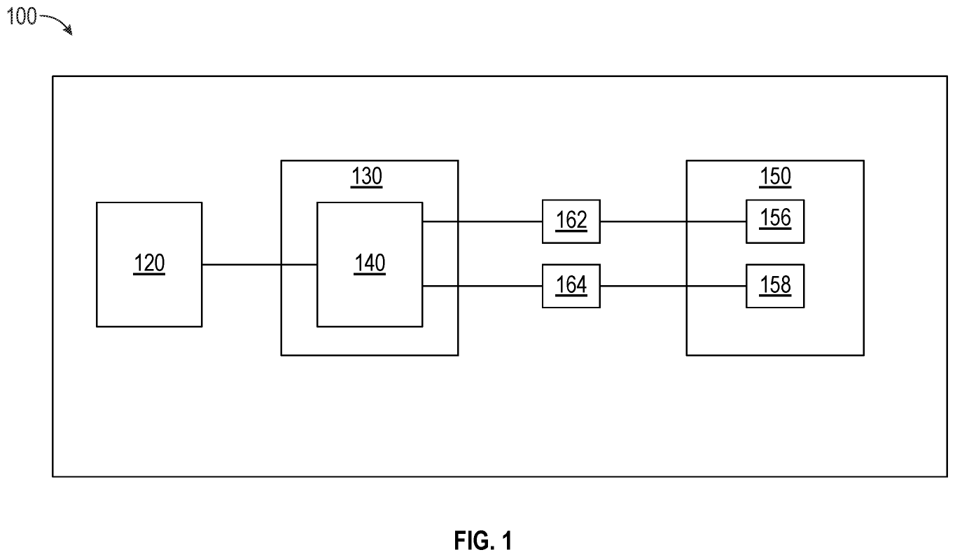

With reference to the figures, FIG. 1 illustrates an example circuit 100 that can be used to provide the desired functionality disclosed herein for a charging system, power delivery module, or charger (e.g., USB panel mount charger 302 shown in FIG. 3, USB embedded charger 802 shown in FIG. 8, etc.). As disclosed herein, the charging system, power delivery module, or charger is configured to be operable for providing power from a single power supply to multiple ports.

As shown in FIG. 1. the exemplary circuit 100 includes a voltage supply 120, a substrate 130, and a power supply 140. The voltage supply 120 is electrically coupled with the power supply 140. The substrate 130 supports the power supply 140. The power supply 140 may be any suitable power supply design depending on the voltage provided by the voltage supply 120. For example, the power supply 140 may include a buck amplifier, a boost amplifier, a buck/boost amplifier, or some other desirable amplifier but in general is a DC to DC power supply. Generally speaking, the power supply can be configured to support different maximum levels of power, such as 30 watts (e.g., 20 V and 1.5 A), 60 watts (e.g., 20V and 3A) or 100 watts (e.g., 20 V and 5 A), consistent with USB PD specifications.

The exemplary circuit 100 further includes first and second controllers 162, 164 electrically coupled with first and second ports 156, 158, respectively. The first and second ports 156, 158 can be individually configured as USB Type-C or USB Type-A ports to provide multiple port module 150 (which can be provided by multiple port module 304 (FIG. 3) or multiple port module 804 (FIG. 8), etc.).

The first controller 162 may be provided on the substrate 130 adjacent the power supply 140. Or the first controller 162 may be located adjacent the first port 156 or located elsewhere. Similarly, the second controller 164 may be provided on the substrate 130 adjacent the power supply 140. Or the second controller 164 may be located adjacent the second port 158 or located elsewhere.

During operation, the first controller 162. is configured to negotiate a power delivery level with a first device connected to the first port 156. And the second controller 164 is configured to negotiate a power delivery level with a second device connected to the second port 158. The first and second controllers 162, 164 are configured to communicate to ensure the appropriate power level is provided to the first and second ports 156, 158 depending on the number of devices connected to the charging system via the first and second ports 156, 158. It should be noted that the first and second controllers 162, 164 can be combined into a single controller.

As long as only one device is connected to the charging system via either the first port 156 or the second port 158, the corresponding first controller 162. or the second controller 164 will negotiate a power delivery level that corresponds to the highest level capable of being received by the connected device and provided by the power supply 140. For example, if the power supply 140 is configured to provide up to 30 watts, then the voltage can be set at 20 volts and the current at 1.5 amps (as provided for in the USB PD specification) when only a single device is connected to the charging system via the first port 156 or second port 158. This is beneficial in that oftentimes there will only be a single user with a single device to be charged while in a vehicle. With exemplary embodiments disclosed herein, a user can plug a single device into either the first port 156 or the second port 158 and still receive the desired 30 watt PD level of power supplied to the single connected device while avoiding the need to include two power supplies (one for each port 156, 158) in the charging system.

When a second device is also connected to the charging system via the other port 156 or 158, the controller(s) (e.g., first or second controller 162, 164, a single controller, etc.) is configured to determine that both ports 156, 158 are each connected to respective devices that are seeking to be charged. As there is a single power supply 140 supporting both ports 156, 158, the charging system can be configured to reduce the power so that the total provided power does not exceed the power rating of the power supply 140. In an embodiment, the power can be reduced to the maximum standard charging power level approved for all USB charging applications (such as, without limitation, 5 volts and 3 amps).

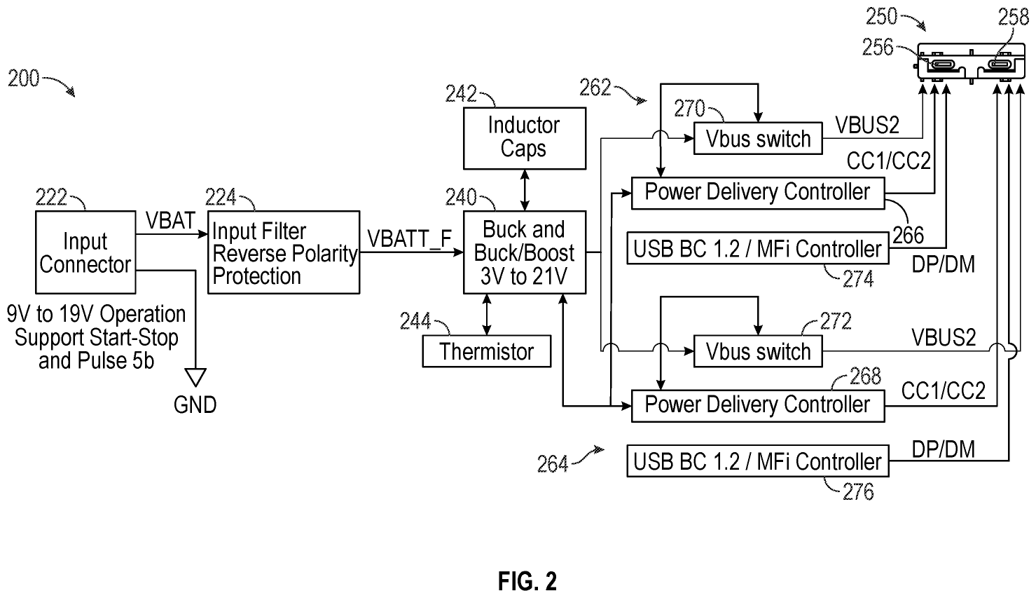

FIG. 2 illustrates an example circuit 200 that can be used to provide the desired functionality disclosed herein for a charging system, power delivery module, or charger (e.g., USB panel mount charger 302 shown in FIG. 3, USB embedded charger 802 shown in FIG. 8, etc.) according to exemplary embodiments of the present disclosure. As disclosed herein, the charging system, power delivety module, or charger is configured to he operable for providing power from a single power supply to multiple ports.

As shown in FIG, 2, the exemplary circuit 200 includes an input connector 222 configured for connection with a voltage supply and ground. The voltage supply may comprise any suitable voltage supply design, e.g., 9V to 19V Operation Support Start-Stop and Pulse 5B, etc. The input connector 222 is also electrically coupled (e.g., via VBAT line, etc.) with an input filter 224, e.g., for reverse polarity protection, etc.

The circuit 200 further includes a power supply 240, which may be any suitable power supply design depending on the voltage provided by the voltage supply via the input connector 222. In the illustrated embodiment shown in FIG. 2, the power supply 240 includes a buck and buck/boost amplifier (e.g., buck/boost amplifier for amplifying 3V voltage supply to 21V voltage output, etc.). Alternatively, the power supply 240 may comprise some other desirable amplifier but in general is a DC to DC power supply.

The power supply 240 is electrically coupled (e.g., via VBATT_F line, etc.) with the input filter 224. The power supply 240 is also electrically coupled with inductor capacitors 242 and a thermistor 244.

The exemplary circuit 200 further includes first and second power delivery controllers 266, 268. The first power delivery controller 266 is electrically coupled (e.g., via CC1/CC2, etc.) with a first port 256. The second power delivery controller 268 is electrically coupled (e.g., via CC1/CC2, etc.) with a second port 258. The first and second ports 256, 258 can be a desired USB configuration and define a multiple port module 250 (e.g., multiple port module 304 (FIG. 3) or multiple port module 804 (FIG. 8), etc.).

The first and second power delivery controllers 266, 268 are electrically coupled with each other and with the power supply 240. The first and second power delivery controllers 266, 268 are electrically coupled with first and second switches 270, 272 (e.g., VBUS switches, etc.), respectively.

The first and second switches 270, 272 are electrically coupled with each other and with the power supply 240. The first switch 270 is also electrically coupled (e.g., via VBUS, etc.) with the first port 256. And the second switch 272 is electrically coupled (e.g., via VBUS, etc.) with the second port 258.

Also shown in FIG. 2 are first and second controllers 274, 276 that are electrically coupled (e.g., via DP/DM, etc.) with the first and second ports 256, 258, respectively. The first controller 274 may include an electronic circuit for the first port 256 to terminate DP/DM lines from an end user device, The second controller 276 may include an electronic circuit for the second port 258 to terminate DP/DM lines from an end user device. In this example, the first and second controllers 274, 276 comprise USB BC1.2/MFi (Battery Charging USB 1.2/Made for iPhone/iPod/iPad) controllers that may include or incorporate BC1.21terminations and USB Type-C connectors for the multiple port module 250.

In this exemplary embodiment shown in FIG. 2, the first power delivery controller 266, Vbus switch 270, and first USB BC1.2/MFi controller 274 may be collectively referred to as a first controller 262. Similarly, the second power delivery controller 268, VBUS switch 272, and second USB BC1.2/MFi controller 276 may be collectively referred to as a second controller 264. And the first and second controllers 262 and 264 may be electrically connected via a vehicle harness (Vbus, CC1, CC2, DP, DM) with the multiple port module 250, which includes the first and second ports 256, 258,

During operation, the first controller 262 is configured to negotiate a power delivery level with a first device connected to the first port 256. The second controller 264 is configured to negotiate a power delivery level with a second device connected to the second port 258. The first and second controllers 262, 264 are configured to communicate to ensure the appropriate power level is provided to the first and second ports 256, 258 depending on the number of devices connected to the charging system via the first and second ports 256, 258. It should be noted that the first and second controllers 262, 264 can be combined into a single controller.

As long as only one device is connected to the charging system via either the first port 256 or the second port 258, the corresponding first controller 262 or the second controller 264 will negotiate a power delivery level that corresponds to the highest level capable of being received by the connected device and provided by the power supply 240. For example, if the power supply 240 is configured to provide up to 30 watts, then the voltage can be set at 20 volts and the current at 1.5 amps (as provided for in the USB PD specification) when only a single device is connected to the charging system via the first port 256 or second port 258. This is beneficial in that oftentimes there will only be a single user with a single device to be charged while in a vehicle. With exemplary embodiments disclosed herein, a user can plug a single device into either the first port 256 or the second port 258 and still receive the desired 30 watt PD level of power supplied to the single connected device while avoiding the need to include two power supplies (one for each port 256, 258) in the charging system.

When a second device is also connected to the charging system via the other port 256 or 258, the controller(s) (e.g., first or second controller 262, 264, a single controller, etc.) is configured to determine that both ports 256, 258 are connected to two respective devices that are seeking to be charged. As there is a single power supply 240 supporting both ports 256, 258, the charging system is configured to reduce the power so that the total power delivery does not exceed the power rating of the power supply 240. In an embodiment, the power can be set to the maximum standard charging power level approved for all USB charging applications (such as, without limitation, 5 volts and 3 amps).

The circuit 200 shown in FIG. 2 may be connected via a vehicle harness to a multiple port module (USB hub with charging and data) or to a multiple port module (PD charger only). The circuit 200 includes or incorporates the input connector 222 for receiving control signals from the vehicle (as required per application) and power lines (Batt+/−). The circuit 200 is configured to convert the input voltage to the required voltage for USB power delivery. The circuit 200 includes circuitry for protecting the electronic components. The circuit 200 also includes the input filter 224 for the EMC noise generated by the conversion circuit. The circuit 200 further includes the USB power delivery controller and output connector (e.g., Vbus, GND, CC1, CC2 per port).

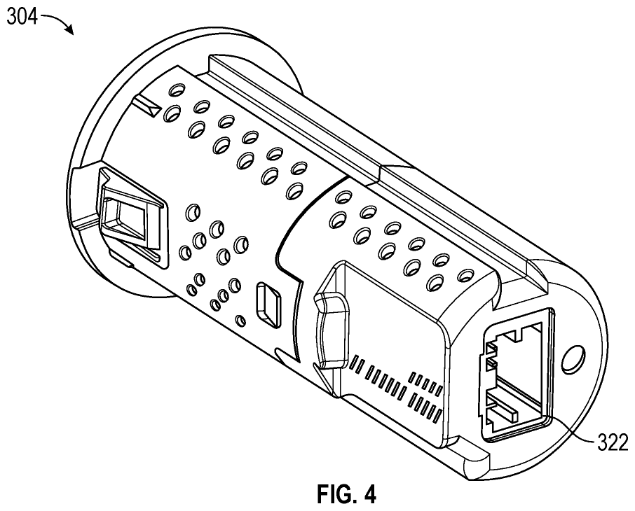

FIG. 3 illustrates a USB panel mount charger 302 including a multiple port module 304 that may include the circuit 100 shown in FIG. 1 and/or the circuit 200 shown in FIG. 2 according to an exemplary embodiment of the present disclosure. In this exemplary embodiment, a vehicle harness including a battery cable 306 is connected (e.g., via input connector 322 (FIG. 4), etc.) with the multiple port module 304. The charger 302 is configured to be operable for providing power to first and second ports 356, 358 of the multiple port module 304. The first and second ports 356, 358 can each be individually configured as USB Type-A or USB Type-C ports.

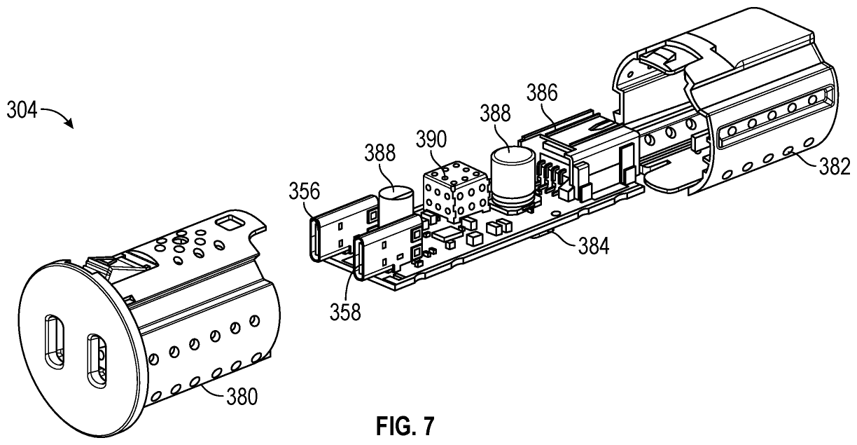

As shown in FIG. 7, the multiple port module 304 includes a housing or mechanical enclosure comprising first and second (or front and back) portions 380, 382 that are removably attachable and detachable from each other. When removably attached to each other, the first and second portions 380, 382 cooperatively define an interior compartment configured for receiving internal components of the multiple port module 304 therein.

In this exemplary embodiment, the multiple port module 304 includes a substrate 384 including or supporting electronic circuits and components thereon. The substrate 384 can be formed in any desired manner, including without limitation, using a traditional printed circuit board technology or via additive processes. The substrate 384 is revealed in FIG. 7 after the first and second portions 380, 382 of the housing or mechanical enclosure have been removably detached (e.g., unlatched, etc.) and separated from each other. As shown in FIG. 7, the substrate 384 includes or supports the first and second ports 356, 358 and other electronic circuits and components, such as input connector and integrated circuit(s) 386, capacitors 388, RF shielding enclosure 390 (e.g., Faraday cage over a power supply, etc.), input filter, thermistor, switches, etc.

FIG. 8 illustrates a USB embedded charger 802 including a multiple port module 804 that may include the circuit 100 shown in FIG. 1 and/or the circuit 200 shown in FIG. 2 according to an exemplary embodiment of the present disclosure. lit this exemplary embodiment, a vehicle harness including a battery cable 806 that couples with the connector 822. Vbu PD, Data+, Data−, GND, CC1, CC2 are signals of the first and second USB Type-C ports 856, 858. The charger 802 is configured to be operable for providing power to first and second USB Type-C ports 856, 858 of the multiple port module 804.

As shown in FIG. 9, the multiple port module 804 includes a housing or mechanical enclosure comprising first and second (or upper and lower) portions 880, 882 that are removably attachable and detachable from each other. When removably attached to each other, the first and second portions 880, 882 cooperatively define an interior compartment configured for receiving internal components of the multiple port module 804 therein.

In this exemplary embodiment, the multiple port module 804 includes a substrate 884 including or supporting electronic circuits and components thereon. The substrate 884 can be formed similar to the substrate 384. The substrate 884 is revealed in FIG. 9 after the first and second portions 880, 882 of the housing or mechanical enclosure have been removably detached (e.g., unlatched, etc.) and separated from each other, As shown in FIG. 9, the substrate 884 includes or supports the first and second ports 856, 858 and other electronic circuits and components, such as input connector and integrated circuit(s) 886, capacitors 888, RF shielding enclosure 890 (e.g., Faraday cage over a power supply, etc.), input filter, thermistor, switches, etc.

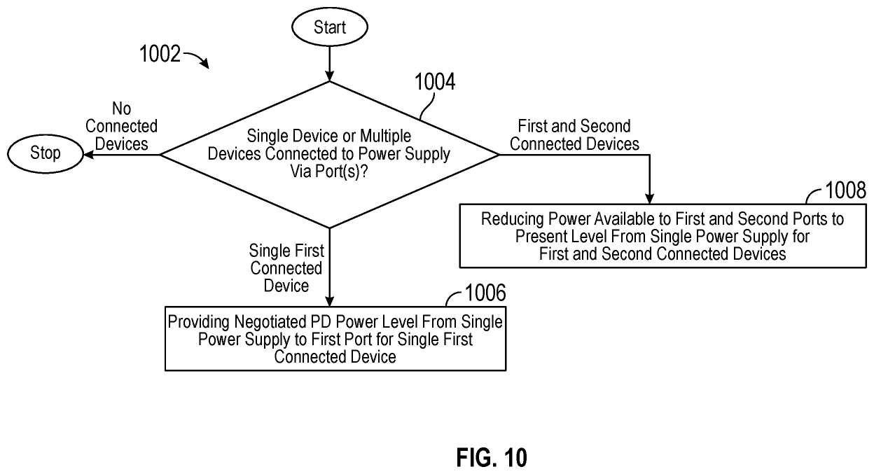

FIG. 10 illustrates an exemplary method 1002 for providing power to a plurality of ports that includes a first port and a second port from a single power supply configured to support Universal Serial Bus (USB) Power Delivery (PD) power levels. At 1004, the method 1002 includes determining or detecting if only a single device or multiple devices are connected to the single power supply via the port(s).

If it is determined at 1004 that only a single first device is connected to the single power supply via a first port, then the method 1002 proceeds to 1006 at which a negotiated PD power level is provided from the single power supply to the first port. Providing the negotiated PD power level at 1006 may comprise providing a negotiated power delivery level that corresponds to the highest level capable of being received by the connected first device and provided by the single power supply.

But if it is determined at 1004 that first and second devices are both connected to the single power supply via corresponding first and second ports, then the method 1002 proceeds to 1008 at which the power available to the first and second ports is reduced to a preset level from the single power supply. Reducing the power available to the first and second ports to a preset level at 1008 may comprise providing a total amount of power that is substantially equal to the power delivery capable of being individually provided to the first port or to the second port. For example, reducing the power available to the first and second ports to the preset level at 1008 may comprise reducing the power to a maximum standard charging power level approved for USB charging applications such that total power delivery does not exceed the power rating of the single power supply.

In addition, the step of reducing the power available to the first and second ports to the preset level at 1008 may comprise communicating between first and second controllers respectively connected to the first and second ports so that an appropriate power level is provided depending on the number of devices connected.

In exemplary embodiments, a charging system includes first and second ports both supported by a single power supply, which is configured to support Universal Serial Bus (USB) Power Delivery (PD) power levels. The first and second ports can be configured to receive a shared voltage from the single power supply. A controller is configured to provide a negotiated PD power level from the single power supply to the first port when, in operation, only a single first device is connected to the charging system via the first port. The controller is further configured to reduce the power available to the first and second ports to a preset level from the single power supply when, in operation, a second device is connected to the charging system via the second port such that the first and second devices are both connected to the charging system.

In exemplary embodiments, the preset level provides a total amount of power that is substantially equal to the power delivery capable of being individually provided to the first port.

In exemplary embodiments, the controller comprises first and second controllers. The first controller is connected to the first port. The second controller is connected to the second port. The first controller is configured to negotiate a power delivery level for a device connected to the first port. The second controller is configured to negotiate a power delivery level for a device connected to the second port. The first and second controllers are configured to communicate to ensure the charging system provides the appropriate power level depending on the number of devices connected to the charging system via the first port and the second port.

In exemplary embodiments, the charging system is configured to operable be with the single power supply such that when only the first device is connected to the charging system via the first port, the first controller is configured to negotiate a power delivery level that corresponds to the highest level capable of being received by the connected first device and provided by the single power supply. When the second device is connected to the charging system via the second port such that the first and second devices are both connected to the charging system, the charging system is configured to reduce the power to a maximum standard charging power level approved for USB charging applications such that total power delivery does not exceed the power rating of the single power supply.

In exemplary embodiments, the single power supply is configured to provide up to 30 watts of power. The controller is configured to set the voltage at 20 volts and the current at 1.5 amps for the first device when only the first device is connected to the charging system via the first port. The controller is configured to set the voltage to 5 volts and the current to 3 amps for each of the first and second devices when the second device is connected to the charging system via the second port such that the first and second devices are both connected to the charging system.

In exemplary embodiments, the charging system is configured to be operable with the single power supply to provide PD power substantially equal to a rated maximum power delivery capability of the single power supply to the first device that is connected to the first port when only the first device is connected to the charging system. The charging system is further configured to controllably switch the single power supply to a reduced shared voltage to the first and second ports when the second device is connected to the charging system via the second port such that the first and second devices are both connected to the charging system, and to supply a same voltage to both the first and second ports while limiting the current to the preset level.

In exemplary embodiments, the first and second ports comprise USB Type-C or USB Type-A ports supported by the same single power supply.

In exemplary embodiments, the single power supply is electrically coupled with the controller, an input filter, one or more inductor capacitors, and a thermistor. And the input filter is electrically coupled between the single power supply and an input connector configured for connection to a voltage supply

In exemplary embodiments, the controller comprises first and second power delivery controllers. The first power delivery controller is electrically coupled with the first port and the single power supply. The second power delivery controller is electrically coupled with the second port, the single power supply, and the first power delivery controller. First and second switches ('e, g., Vbus switches, etc.) may be electrically coupled with the first and second power delivery controllers, respectively. The first and second controllers (e.g., USB BC1.2/MFI controllers, etc.) may be electrically coupled with the first and second ports, respectively. The first controller may include an electronic circuit for the first port to terminate DP/DM lines from an end user device. The second controller may include an electronic circuit for the second port to terminate DP/DM lines from an end user device.

In exemplary embodiments, the charging system comprises a multiple port module including the first and second ports and the controller.

In exemplary embodiments, the multiple port module includes a printed circuit board assembly or other substrate comprising one or more electronic circuits and components thereon including the first and second ports and the controller. The multiple port module also includes a mechanical enclosure configured to protect the one or more electronic circuits and components of the printed circuit board assembly.

In exemplary embodiments, the charging system comprises a power block including the single power supply. The charging system also includes a harness configured to interconnect the power block with the multiple port module.

In exemplary embodiments, the multiple port module includes an input connector for receiving Vbus, CND, CC1, and CC2 lines per port from the power block. The multiple port module can also include a USB Type-C or Type-A connector per port to interface with an end user device.

In exemplary embodiments, the multiple port module includes an input connector for high speed USB data lines, and an electronic circuit including a USB hub and circuitry for providing USB functionality. Additionally, or alternatively, the multiple port module includes an electronic circuit per port to terminate DP/DM lines from an end user device.

In exemplary embodiments, the power block includes one or more input connectors for receiving power, control, and/or communication lines from a vehicle; an input filter to support vehicle transients and clean electromagnetic noise generated by the power block; a switching mode DC-DC converter to generate a voltage required by USB power delivery (PD); a USB power delivery (PD) controller per port to drive the switching mode DC-DC converter and communicate with an end user device via CC1 and CC2 lines; electrostatic discharge (ESD) protection for signal and power lines (Vbus, GND, CC1 and CC2) per port; and an output connector to connect with the harness.

In exemplary embodiments, the power block is embedded within an electronic control unit (ECU) of a vehicle. For example, the power block may be embedded within an electronic control unit (ECU) of a vehicle that comprises a wireless charger. Alternatively, the power may comprise a standalone power module.

In exemplary embodiments, the charging system includes a high-speed data cable configured to connect the multiple port module with a host for a USB hub application.

Also disclosed are exemplary methods for providing power to a plurality of ports that includes a first port and a second port from a single power supply configured to support Universal Serial Bus (USB) Power Delivery (PD) power levels. In exemplary embodiments the method comprises providing a negotiated PD power level from the single power supply to the first port after determining that only a single first device is connected to the single power supply via the first port. The method also comprises reducing the power available to the first and second ports to a preset level from the single power supply after determining that a second device is connected to the single power supply via the second port such that the first and second devices are both connected to the single power supply via the corresponding first and second ports.

In exemplary embodiments, reducing the power available to the first and second ports to a preset level comprises providing a total amount of power that is substantially equal to the power delivery capable of being individually provided to the first port or to the second port.

In exemplary embodiments, the first port is connected to a first controller, and the second port is connected to a second controller. The step of reducing the power method comprises communicating between the first and second controllers so that an appropriate power level is provided depending on the number of devices connected to the single power supply via the plurality of ports.

In exemplary embodiments, the method includes after determining that only the first device is connected to the single power supply via the first port, providing a negotiated power delivery level that corresponds to the highest level capable of being received by the connected first device and provided by the single power supply. The method also includes after determining that the second device is connected to the single power supply via the second port such that the first and second devices are both connected to the single power supply via the corresponding first and second ports, reducing the power to a maximum standard charging power level approved for USB charging applications such that total power delivery does not exceed the power rating of the single power supply.

In exemplary embodiments, the method includes after determining that only the first device is connected to the single power supply via the first port, providing PD power substantially equal to a rated maximum power delivery capability of the single power supply to the first device that is connected to the first port. The method also includes after determining that the second device is connected to the single power supply via the second port such that the first and second devices are both connected to the single power supply via the corresponding first and second ports, controllably switching the single power supply to a reduced shared voltage to the first and second ports and supplying a same voltage to both the first and second ports while limiting the current to the preset level.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1.-20. (canceled)

21. A charging system comprising:
a single power supply configured to support Universal Serial Bus (USB) Power Delivery (PD) power levels;
a first port and a second port, both the first port and the second port supported by the single power supply, the first and second ports configured to receive a shared voltage from the single power supply; and
a controller configured to:
provide a negotiated voltage level from the single power supply to the first port when, in operation, only a single first device is connected to the charging system via the first port; and
reduce the voltage provided to the first port from the negotiated voltage level to a preset voltage level, wherein the same voltage is provided to the first and second ports,—when, in operation, a second device is connected to the charging system via the second port such that the first and second devices are both connected to the charging system.

22. The charging system of claim 21, wherein the controller is configured to reduce the voltage provided to the first port from the negotiated voltage level to the preset voltage level such that a total amount of power is provided that is substantially equal to the power delivery capable of being individually provided to the first port.

23. The charging system of claim 21, wherein the controller comprises:
a first controller connected to the first port; and
a second controller connected to the second port.

24. The charging system of claim 23, wherein:
the first controller is configured to negotiate a voltage level for a device connected to the first port;
the second controller is configured to negotiate a voltage level for a device connected to the second port; and
the first and second controllers are configured to communicate to ensure the charging system provides an appropriate voltage level depending on the number of devices connected to the charging system via the first port and the second port.

25. The charging system of claim 23, wherein the charging system is configured to be operable with the single power supply such that:
when only the first device is connected to the charging system via the first port, the first controller is configured to negotiate a voltage level that corresponds to the highest level capable of being received by the connected first device and provided by the single power supply; and
when the second device is connected to the charging system via the second port such that the first and second devices are both connected to the charging system, the charging system is configured to reduce the voltage such that power is reduced to a maximum standard charging power level approved for USB charging applications and such that total power delivery does not exceed the power rating of the single power supply.

26. The charging system of claim 21, wherein:
the single power supply is configured to provide up to 30 watts of power;
the controller is configured to set the voltage at 20 volts and the current at 1.5 amps for the first device when only the first device is connected to the charging system via the first port; and
the controller is configured to set the voltage to 5 volts and the current to 3 amps for each of the first and second devices when the second device is connected to the charging system via the second port such that the first and second devices are both connected to the charging system.

27. The charging system of claim 21, wherein the charging system is configured to be operable with the single power supply to:
provide PD power substantially equal to a rated maximum power delivery capability of the single power supply to the first device that is connected to the first port when only the first device is connected to the charging system; and
controllably switch the single power supply to a reduced shared voltage to the first and second ports when the second device is connected to the charging system via the second port such that the first and second devices are both connected to the charging system, whereby the charging system supplies the same voltage to both the first and second ports while limiting the current to a preset level.

28. The charging system of claim 21, wherein:
the single power supply is electrically coupled with the controller, an input filter, one or more inductor capacitors, and a thermistor; and
the input filter is electrically coupled between the single power supply and an input connector configured for connection to a voltage supply.

29. The charging system of claim 21, wherein the controller comprises:
a first power delivery controller electrically coupled with the first port and the single power supply; and
a second power delivery controller electrically coupled with the second port, the single power supply, and the first power delivery controller.

30. The charging system of claim 29, wherein the charging system includes:
a first switch electrically coupled with the first power delivery controller, and a second switch electrically coupled with the second power delivery controller; and/or
a first controller electrically coupled with the first port that includes an electronic circuit for the first port to terminate DP/DM lines from an end user device, and a second controller electrically coupled with the second port that includes an electronic circuit for the second port to terminate DP/DM lines from an end user device.

31. The charging system of claim 21, wherein the charging system comprises a multiple port module including the first and second ports and the controller.

32. The charging system of claim 31, wherein the charging system comprises:
a power block including the single power supply; and
a harness configured to interconnect the power block with the multiple port module.

33. The charging system of claim 32, wherein the multiple port module includes:
an input connector for receiving bus, GND, CC1, and CC2 lines per port from the power block; and
a USB Type-C or Type-A connector per port to interface with an end user device.

34. The charging system of claim 33, wherein:
the multiple port module includes an input connector for high speed USB data lines, and an electronic circuit including a USB hub and circuitry for providing USB functionality; and/or
the multiple port module includes an electronic circuit per port to terminate DP/DM lines from an end user device.

35. The charging system of claim 32, wherein the power block includes:
one or more input connectors for receiving power, control, and/or communication lines from a vehicle;
an input filter to support vehicle transients and clean electromagnetic noise generated by the power block;
a switching mode DC-DC converter to generate a voltage required by USB power delivery (PD);
a USB power delivery (PD) controller per port to drive the switching mode DC-DC converter and communicate with an end user device via CC1 and CC2 lines;
electrostatic discharge (ESD) protection for signal and power lines (Vbus, GND, CC1 and CC2) per port; and
an output connector to connect with the harness.

36. The charging system of claim 32, wherein:
the power block is embedded within an electronic control unit (ECU) of a vehicle; or
the power block comprises a standalone power module.

37. A method for providing power to plurality of ports that includes a first port and a second port from a single power supply configured to support Universal Serial Bus (USB) Power Delivery (PD) power levels to the plurality of ports, the method comprising:
providing a negotiated voltage level from the single power supply to the first port after determining that only a single first device is connected to the single power supply via the first port; and
reducing the voltage provided to the first port from the negotiated voltage level to a preset voltage level whereby the same voltage is provided to the first and second ports, after determining that a second device is connected to the single power supply via the second port such that the first and second devices are both connected to the single power supply via the corresponding first and second ports.

38. The method of claim 37, wherein reducing the voltage provided to the first port from the negotiated voltage level to the preset voltage level comprises providing a total amount of power that is substantially equal to the power delivery capable of being individually provided to the first port or to the second port.

39. The method of claim 37, wherein the first port is connected to a first controller, the second port is connected to a second controller, and the step of reducing the voltage comprises communicating between the first and second controllers so that an appropriate voltage level is provided depending on the number of devices connected.

40. The method of claim 37, wherein the method includes:
after determining that only the first device is connected to the single power supply via the first port, providing a negotiated voltage level that corresponds to the highest level capable of being received by the connected first device and provided by the single power supply; and
after determining that the second device is connected to the single power supply via the second port such that the first and second devices are both connected to the single power supply via the corresponding first and second ports, reducing the voltage such that power is reduced to a maximum standard charging power level approved for USB charging applications and such that total power delivery does not exceed the power rating of the single power supply.
